(19) United States
(12) Patent Application Publication
(10) Pub. No.: US 2009/0267329 A1
(43) Pub. Date: Oct. 29, 2009

(54) Invisible Pre-Weakened Seam for an Air Bag Deployment Cover

(76) Inventors: Raymond E. Kalisz, Livonia, MI (US); Kenneth J. Kwasnik, Shelby Township, MI (US); Deepak N. Patel, Canton, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 12/111,684

(22) Filed: Apr. 29, 2008

(51) Int. Cl. B60R 21/215

(52) U.S. Cl. 280/728.3

(57) ABSTRACT

A cover panel for the air bag in an automotive vehicle with a pre-weakened tear seam being formed by a series of voids formed in a predetermined repeat pattern of varying depths. The voids are formed by ablating the cover panel base substrate from its under side at varying depths to weaken both the base substrate and an outer finish layer.

### BACKGROUND

1. Field of the Invention

This invention relates to the field of air bag deployment covers for an automotive vehicle and more particularly to the area of a cover panel structure that has a pre-weakened seam formed for air bag deployment.

2. Description of the Prior Art

Most recently in this technology field, there is a desire to make the air bag deployment door in instrument panels and other locations invisible to occupants of the vehicle and achieve a desired aesthetic for vehicle interiors. Several patents show various techniques and materials used to form cover panels with invisible air bag deployment doors.

U.S. Pat. No. 6,453,535 discloses a process that employs a laser to provide a concealed deployment door and opening in a substrate panel. In that patent, the pre-weakened scoring traces out the door except for bridging tabs which remain to provide support for the door member.

U.S. Pat. No. 6,808,197 discloses a process that employs a multi-axis laser manipulator for providing continuous controlled scoring of the inside of an instrument panel to form a pre-weakened pattern.

U.S. Pat. No. 7,100,941 discloses various techniques of pre-weakening an outer woven material, including weakening the fabric from either the front or backsides by thinning, cutting or melting and by weaving in weaker yarns to define the pre-weakened pattern.

While none of the prior art patents suggest the invention claimed herein, they disclose similar materials and mechanisms that could be used for achieving the invention. Therefore, the above-cited patents are incorporated herein by reference.

### SUMMARY OF THE INVENTION

The present invention is directed to an improved air bag opening cover such as is located on the passenger side instrument panel of an automotive vehicle. However, the invention is also suited for a driver side steering wheel mounted air bag system or any other location where a pre-weakened and externally invisible tear seam is required.

With the variety of materials increasing for automotive interiors, it has been found that conventional scoring and pre-weakening techniques are not always effective to ensure that a deployment door can be formed which is invisible to the vehicle occupant, has the strength properties to resist inward pressures and opens properly during air bag deployment. The present invention may be implemented by utilizing a controlled energy beam (laser) to precisely erode a series of voids at predetermine depths in the backside of a panel substrate to define the pre-weakened path for a tear seam. By using a predetermined depth pattern, one is able, depending on the particular type of external skin material that is laminated or otherwise attached to the base substrate, to create both weakness and strength at an optimum level for the desired characteristics of flexible hinge and rupturable tear seam portions.

The invention is particularly useful when the external skin material includes a woven or mesh fabric as part of its laminate make up. Woven or mesh layers are generally quite strong and particularly resistant to tearing unless they have been physically pre-weakened. In this invention, the entire tear seam is defined by a series of spaced apart voids, but the weakening of the external skin material is only periodically weakened by groups of generally conical shaped voids being formed to a depth that extends from the inner surface of the substrate and into the external skin material layer, without penetrating through it. In this configuration, the tear seam is defined so that during deployment of the underlying air bag, the outward pressure provided by the expanding air bag causes the base structure to rupture along the tear seam and the external skin material to separate at the pre-weakened portions and migrate the tearing along the seam to the other like pre-weakened portions. By providing a predetermined depth pattern of spaced apart voids along the tear seam, sufficient strength is retained across the seam to also prevent cave in due to pressure that may be applied against the external skin material during normal occupant usage of the vehicle.

It is an object of the present invention to provide a cover panel for an automotive vehicle that contains a defined air bag deployment door. The cover panel includes a relatively rigid base substrate structure having an outer surface and an inner surface and an outer finish skin material that is attached to and overlying the outer surface. A series of spaced apart voids are formed in the base substrate to define the outline of a deployment door in the cover panel. The voids are formed along a line on at least one portion of the base substrate to define a hinge seam of the deployment door and are formed along other continuous portions extending from the hinge seam to define the opening edges of the deployment door and a corresponding tear seam. The series of voids that are formed in the base substrate extend from the inner surface of the base substrate at varying depths in a predetermined repeat pattern of depth.

It is another object of the present invention to provide a cover panel in which the series of voids defining the tear seam include a first predetermined series of voids having a first depth alternating with a second predetermined series of voids having a second depth to form a predetermined repeat pattern.

It is a further object of the present invention to provide a cover panel in which the series of voids defining the tear seam tear seam having a first depth extend from the inner surface of the base substrate towards the outer surface the base substrate without penetrating the outer surface and the series of voids defining the tear seam having a second depth extend from the inner surface of the base substrate towards the outer surface to penetrate the outer surface and weaken the outer finish skin material without fully penetrating through the outer finish skin material.

### BRIEF DESCRIPTION OF THE DRAWINGS

FIG. 1 is a perspective view of a portion of an interior cover panel having an air bag deployment door formed according to the present invention.

FIG. 2 is a cross-sectional view of a portion II of the tear seam shown in FIG. 1 and illustrating a series of voids formed with varying depths in a predetermined repeat pattern of depth.

### DETAILED DESCRIPTION

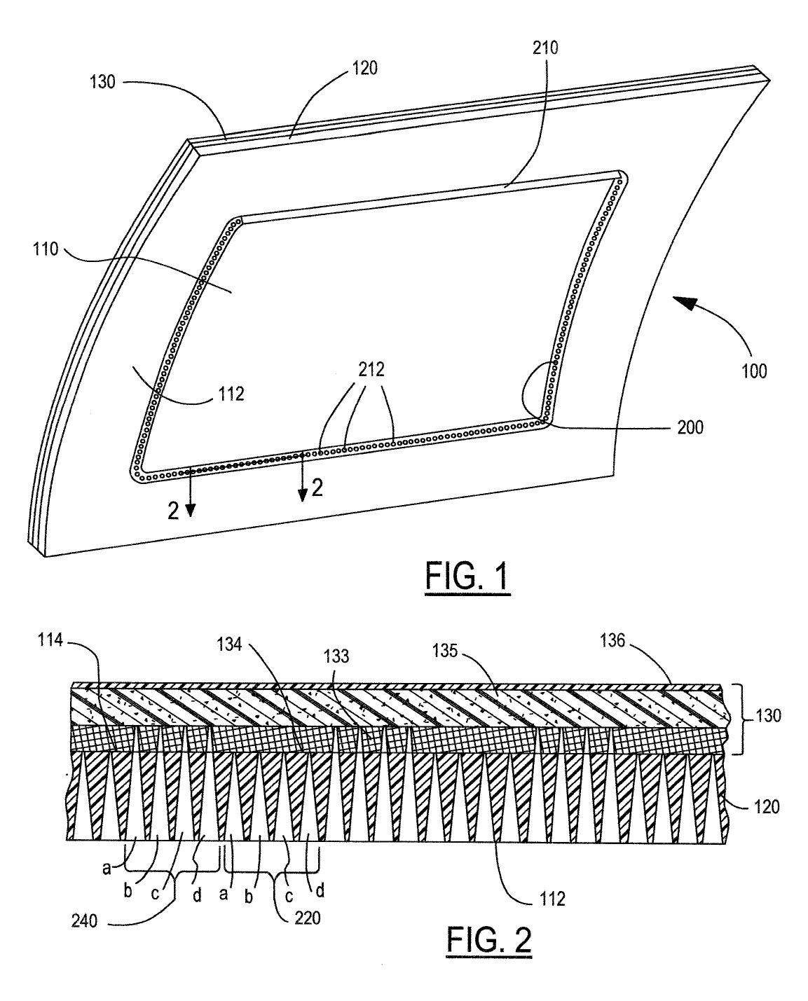

The cover panel 100, shown in FIG. 1, is a portion of a larger structure such as a passenger side instrument panel, as viewed from its underside. However, it equally represents a driver side knee bolster panel, a steering wheel hub cover, or any other interior panel of an automotive vehicle through which an air bag can be deployed. Cover panel 100 is formed of a relatively rigid base structure 120 such as plastic or other material that provides the desired strength and rigidity for the panel. In the preferred embodiment, a thermoplastic substrate on the order of 4 mm is utilized. Base structure 120 has an inner surface 11 2 and an outer surface 1 14 (FIG. 2). An external skin material 130 is attached to the outer surface 114 of the base structure 120 and is typically made as a laminate as will be describe with reference to FIG. 2.

Cover panel 100 is shown with an air bag deployment door 1 10 formed therein by a pre-weakened tear seam 200 which includes a hinge portion 210 along one edge and a rupturable portion 212 continuously extending from and joined to the ends of hinge portion 210. Although the embodiment shown has a single hinge portion 210 to provide a “C” deployment door configuration, the present invention is equally applicable to other embodiments in which there are a plurality of deployment doors and separate hinges, such as the conventionally known “H” deployment door configuration.

In FIG. 2, a cross-sectional view is presented of a small portion II of the rupturable portion 212 of tear seam 210. The cross-sectional view illustrates the layers which make up the cover panel 100 and the series of spaced apart voids created to define the tear seam and the depth repeat pattern of the voids utilized in the preferred embodiment. In this embodiment, base substrate structure 120 is a formed from a thermoplastic resin such as polypropylene having an inner surface 212 and an outer surface 114. An outer finish skin material 130 having an inner surface 134 and an outer skin (class A) 136 is attached to and overlying outer surface 114 of base substrate structure 120. In this case the inner surface 134 of outer skin material 130 is adhesively attached to outer surface 114 to form a laminate. In this embodiment, a commercially available product under the trade name Benova® is employed as the outer finish skin material 130. This material is itself a laminate of various layers, including an intermediate woven fabric layer 133 of polypropylene and other layers of a foam material 135 and an outer skin 136. Although not shown, an underlayment mesh may be adhesively laminated between the outer surface 114 of base substrate 120 and the inner surface 134 of outer skin material 130. Other materials are also suitable, such as leather bonded to a woven carrier.

The use of woven material in the cover panel 100 provides a high quality appearing surface to the vehicle occupants and can be laid up on the base substrate on a permanent basis without the prospects of bubbles other flaws later appearing due to delamination. It also offers high strength and is inherently resistant to tearing. Prior to developing the present invention, the task of creating a pre-weakened seam for a cover panel offered several challenges. The seam must be invisible to vehicle occupants. The hinge portion of the tear seam must both allow the air bag deployment door 110 to rotate out of the way of the air bag during air bag deployment and provide sufficient structure so that the door 110 remains tethered to the cover 100 both before and after air bag deployment. The tear seam that defines the edges of the air bag deployment door 110 must be sufficiently weakened to allow the outward pressure provided by the air bag during deployment to immediately rupture in a smooth manner over its entire length. The tear seam that defines the edges of the air bag deployment door 110 must be sufficiently strong to resist fracturing cave in due to inward pressure from occupant contact with the deployment door 110 that would otherwise result in an indented appearance.

The above-stated characteristics have been achieved in the present invention with a series of spaced apart void groups 220 and 240 repeatedly formed in the base substrate 120 to define the edges of deployment door 110 in the cover panel 100. Voids are formed along a closed line 200 to define hinge seam 210 and rupturable tear seam 212.

The voids are formed by utilizing a focused beam of energy, (e.g. laser beam) of sufficient intensity to cause rapid ablatement of the base substrate material 120 and in controlled circumstances, a portion of the outer finish skin material 130. Several laser cutters and ablatement devices are on the market that can be controlled to provide the energy requirements of the present invention and that detail is not provided here except by reference to prior art patents incorporated above. Control of speed in an x-y axis, the focal length of the optics, as well as pulse duration and pulse intensity are all variable characteristics that are necessary to implement such equipment and control the depth, cross-section sizes and spacing of the voids.

The series of voids that are formed in the base substrate material 120 extend from the inner surface of the base substrate at varying depths in a predetermined repeat pattern of depth. A first group of voids 220 is made up of generally conical individual voids 220a, 220b, 220c and 220d each formed with a comparatively shallow depth to provide a weakening over a predetermined portion of the base substrate material 120 only. Although voids 220a, 220b, 220c and 220d in FIG. 2 are shown to extend from the inner surface 112 to the outer surface 114, it should be understood that those voids could be somewhat shallower and achieve the same pre-weakening result, depending on the particular material being employed as the base substrate material 120. A second group of voids 240 is made up of individual voids 240a, 240b, 240 and 240d each formed with a comparatively longer depth to provide a weakening over a predetermined portion of both the base substrate material 120 and the outer finish skin material 130. In the case of the second group of voids 240, they are sufficiently deep to penetrate the woven material layer 133, but not deep enough to penetrate the outer skin 136.

The first and second groups of voids 220 and 240 are alternately and repeatedly formed in a predetermined repeat pattern of depth over the entire length of the tear seam 212 to create a continuous line of weakness in the base substrate material 120 and a dashed line of weakness in the outer finish skin material 130, which are co-extensive because they are superimposed, one over the other. It has been found that the predetermined repeat pattern of 4 shallow followed by 4 deep voids is suitable for the current embodiment. It is foreseeable that other patterns could be more suitable when applied to other material layer combinations. Also, variations in void volume and the number of spaced apart voids along a measured distance can be made.

In the hinge portion 210, only the shallower depth groups of voids 220 are repeated along the length of the hinge to prevent weakening of the outer finish skin material 130. This allows the outer finish skin material 130 to retain its inherent strength and act as the flexible hinge for the deployment door 110 while tethering it to the cover panel 100 during air bag deployment.

As can be seen by the drawings and accompanying explanation, the present invention is a unique improvement over conventional air bag cover panels. And while the embodiment shown here is the preferred embodiment, it shall not be considered to be a restriction on the scope of the claims set forth below.

We claim:

1. A cover panel for an automotive vehicle that contains a defined air bag deployment door, comprising:
a relatively rigid base substrate structure having an outer surface and an inner surface;
an outer finish skin material being attached to and overlying said outer surface;
a series of spaced apart voids formed in said base substrate to define the outline of a deployment door in said cover panel, said voids being formed along a line on at least one portion of said base substrate to define a hinge seam of said deployment door and being formed along other continuous portions extending from said hinge seam to define the opening edges of said deployment door and a corresponding tear seam;
wherein said series of voids formed in said base substrate extend from said inner surface of said base substrate define said tear seam and are at varying depths in a predetermined repeat pattern of depth.

2. A cover panel as in claim 1, wherein the series of voids defining said hinge seam extend from said inner surface of said base substrate towards said outer surface without penetrating said outer surface.

3. A cover panel as in claim 1, wherein the series of voids defining said tear seam include a first predetermined series of voids having a first depth alternating with a second predetermined series of voids having a second depth to form said predetermined repeat pattern of depth.

4. A cover panel as in claim 3, wherein said first series of voids defining said tear seam having said first depth extend from said inner surface of said base substrate towards said outer surface without penetrating said outer surface and said second series of voids defining said tear seam having said second depth extend from said inner surface of said base substrate towards said outer surface to penetrate said outer surface.

5. A cover panel as in claim 4, wherein said second series of voids defining said second depth extend from said inner surface of said base substrate towards said outer surface to penetrate said outer surface and weaken said outer finish skin material without fully penetrating through said outer finish skin material.

6. A cover panel as in claim 4, wherein said outer finish skin material contains at least one intermediate layer that is a woven fabric and said second series of voids defining said second depth extend from said inner surface of said base substrate towards said outer surface to penetrate said outer surface and weaken said outer finish skin material also penetrates said woven layer without fully penetrating said outer finish skin material.

7. A cover panel as in claim 4, wherein said outer finish skin material is formed from a laminated plurality of layers including an outer skin layer and at least one layer of woven material, wherein said layers are bonded on the outer surface of said rigid base substrate structure, and said second series of voids defining said second depth extending from said inner surface of said base substrate towards said outer surface penetrate said outer surface and weaken said outer finish skin material also penetrate said woven layer without fully penetrating said outer skin layer.

8. A cover panel as in claim 7, wherein said outer skin material is adhesively bonded to said outer surface of said rigid base substrate structure.

9. A cover panel as in claim 7, wherein said outer skin layer is leather.

10. A cover panel as in claim 1, wherein said series of voids formed in said base substrate extend from said inner surface of said base substrate at varying depths in a predetermined pattern of depth, void volume and number over a measured distance.

11. A cover panel as in claim 1, wherein said series of voids formed in said base substrate are generally conical in cross-section.

12. A cover panel as in claim 1, wherein said series of voids are each formed by a beam of energy directed at said inner surface of said base substrate controlled in its cross-sectional size, intensity and duration.

13. A cover panel as in claim 1, wherein said cover panel is a passenger side instrument panel.

14. A cover panel as in claim 4, wherein said first and second groups of voids are alternately and repeatedly formed in a predetermined repeat pattern of depth over the entire length of the tear seam to create a continuous line of weakness in the base substrate material and a dashed line of weakness in the outer finish skin material.

15. A cover panel as in claim 14, wherein said continuous and said dashed lines are co-extensive.

16. A method of forming an air bag deployment cover integrated with an interior cover panel in an automotive vehicle, comprising the steps of:
providing a cover panel having a relatively rigid base substrate structure with an outer surface and an inner surface;
providing and attaching an outer finish skin material to and overlying said outer surface;
forming a series of spaced apart voids that extend from said inner surface of said base substrate to define the outline of an air bag deployment cover in said cover panel;
wherein said step of forming includes the step of forming said voids along a line on at least one portion of said defined the outline to define a hinge seam of said air bag deployment cover;
wherein said step of forming further includes the step of forming said voids along other continuous portions of said base substrate extending from said hinge seam to define the opening edges of said air bag deployment cover and a corresponding tear seam;
wherein said step of defining said tear seam includes the step of forming said voids in said base substrate to extend from said inner surface at varying depths in a predetermined repeat pattern of depths.

17. A method as in claim 16, wherein said step forming said voids in said base substrate to extend from said inner surface at varying depths in a predetermined repeat pattern of depths includes the step of forming said voids in a first predetermined group of voids having a first depth alternating with a second predetermined group of voids having a second depth to form said predetermined repeat pattern of depths.

18. A method as in claim 17, wherein said step of forming said first predetermined group of voids to extend from said inner surface of said base substrate towards said outer surface is performed to not penetrate said outer surface and said step of forming said second predetermined group of voids to extend from said inner surface of said base substrate towards said outer surface is performed to penetrate said outer surface.

19. A method as in claim 18, wherein said step of providing said outer finish skin material is performed to include at least one intermediate layer that is a woven fabric, and s said step of forming said second predetermined group of voids to extend from said inner surface of said base substrate towards said outer surface is performed to penetrate said outer surface and also penetrate said woven layer without fully penetrating said outer finish skin material.

20. A method as in claim 19, wherein said step of attaching said outer finish skin material to and overlying said outer surface is performed by adhesive bonding.
